(19) United States
(12) Patent Application Publication
(10) Pub. No.: US 2014/0317489 A1
(43) Pub. Date: Oct. 23, 2014

(54) DEVICE-INDEPENDENT VALIDATION OF WEBSITE ELEMENTS

(71) Applicant: MICROSOFT CORPORATION, Redmond, WA (US)

(72) Inventors: Rahul Ravindra Lal, Redmond, WA (US); Shama Sharad Joshi, Bellevue, WA (US); Marcelo Medeiros De Barros, Redmond, WA (US); Kalpesh Sureshchandra Bhimani, Bothell, WA (US); David Russell Federman, Renton, WA (US); Nanda Kishore Sreerama, Redmond, WA (US)

(21) Appl. No.: 13/865,731

(22) Filed: Apr. 18, 2013

(51) Int. Cl. G06F 17/22

(52) U.S. Cl. CPC G06F 17/2247
USPC 715/234

(57) ABSTRACT

Validating a webpage to determine whether components (e.g., user-interface elements) of the webpage render properly includes various elements. For example, a server-hosted JavaScript solution provides a webpage-validation test suite for execution on a local computing device. The test suite is executable locally in an iFrame and allows validation from any device that supports JavaScript.

### BACKGROUND

Web pages are often designed to be rendered in various contexts, such as by different devices having respective form factors, browsers, device specs (e.g., screen resolution), and the like. For example, multiple versions of a webpage might be created, each version including a respective set of user-interface designed for a specific hardware or software. The respective set of components helps to provide a context-specific rendering.

When a version of a webpage is created, it can be helpful to validate the webpage before publishing to verify that the webpage will be rendered properly when executed by a device having a targeted operating environment (i.e., hardware and software capabilities). For example, validation can verify that a user-interface element appears and functions properly.

### SUMMARY

Embodiments of the invention are defined by the claims below, not this summary. Rather, this summary merely provides a high-level overview of various aspects of the invention and introduces a selection of concepts that are further described below in the detailed-description section. This summary is not intended to identify key features or essential features of the claimed subject matter, nor is it intended to be used as an aid in isolation to determine the scope of the claimed subject matter.

An embodiment of the present invention is directed to validating a webpage to determine whether components (e.g., user-interface elements) of the webpage render properly. A server-hosted JavaScript solution provides a webpage-validation test suite for execution on a local computing device. The test suite is executable locally in an iFrame and allows validation from any device that supports JavaScript.

### BRIEF DESCRIPTION OF THE DRAWINGS

Illustrative embodiments of the present invention are described in detail below with reference to the attached figures, which are incorporated herein by reference, wherein:

FIG. 1 depicts an exemplary computing device in accordance with an embodiment of the present invention;

FIG. 2 depicts an exemplary computing environment in accordance with an embodiment of the present invention; and

FIGS. 3 and 4 each depict depicts a respective flow diagram having a set of steps in accordance with embodiments of the present invention.

### DETAILED DESCRIPTION

The subject matter of embodiments of the present invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly stated

An embodiment of the present invention is directed to a webpage-validation system, which provides a server-hosted JavaScript solution. Using the JavaScript solution, a client device that supports JavaScript registers a webpage with the system. Rendering contexts (e.g., device, device type, browser, device specs, etc.) are specified and validation rules are compiled to create a JavaScript test suite. The set of JavaScript is then provided to the client device to be inserted into a tag and executed locally in an iFrame. That is, the webpage to be tested is launched in the iFrame, and a handler is provided to the test-suite script, which passes it to the various rendering contexts. Embodiments of the present invention might be used to validate various aspects of a web page, such as user-interface elements, search-result ranking, and the like.

In a further embodiment of the present invention, logging and error detection is provided by the common scripts included by the handler. The logs generated by the suite execution are then provided (e.g., e-mailed or published on a specified URL) where a user can get details on the performance of the test pass.

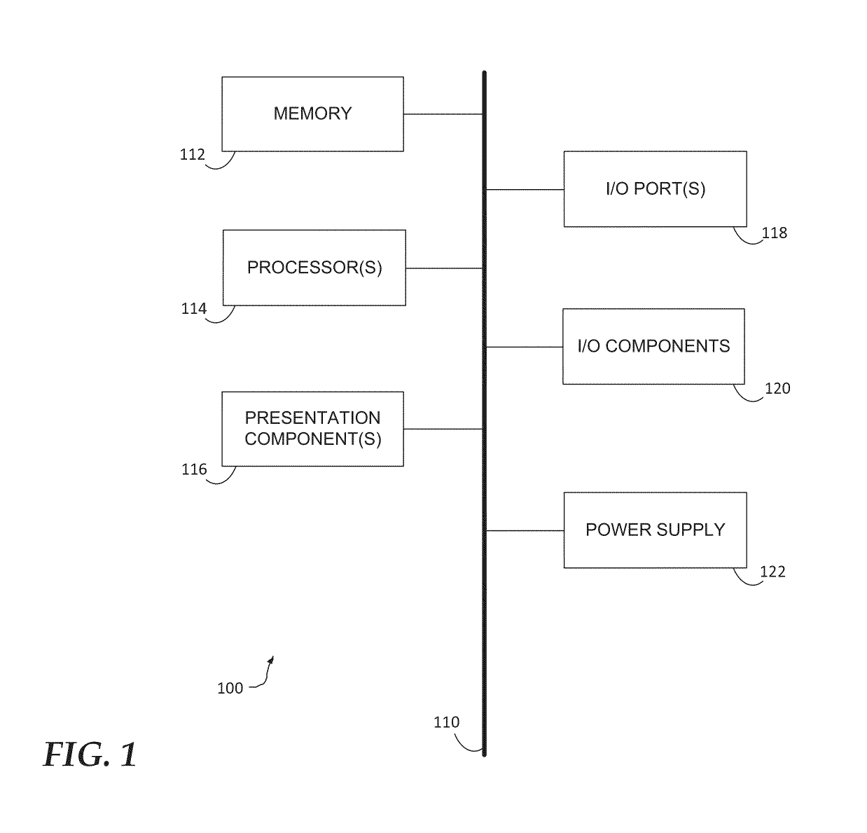

Having generally described embodiments of the present invention, reference is made to FIG. 1 to describe an exemplary computing device 100 in accordance with an embodiment of the present invention. The computing device 100 is but one example of a suitable computing environment and is not intended to suggest any limitation as to the scope of use or functionality of invention embodiments. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other devices which can be used to store the desired information and which can be accessed by computing device 100.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

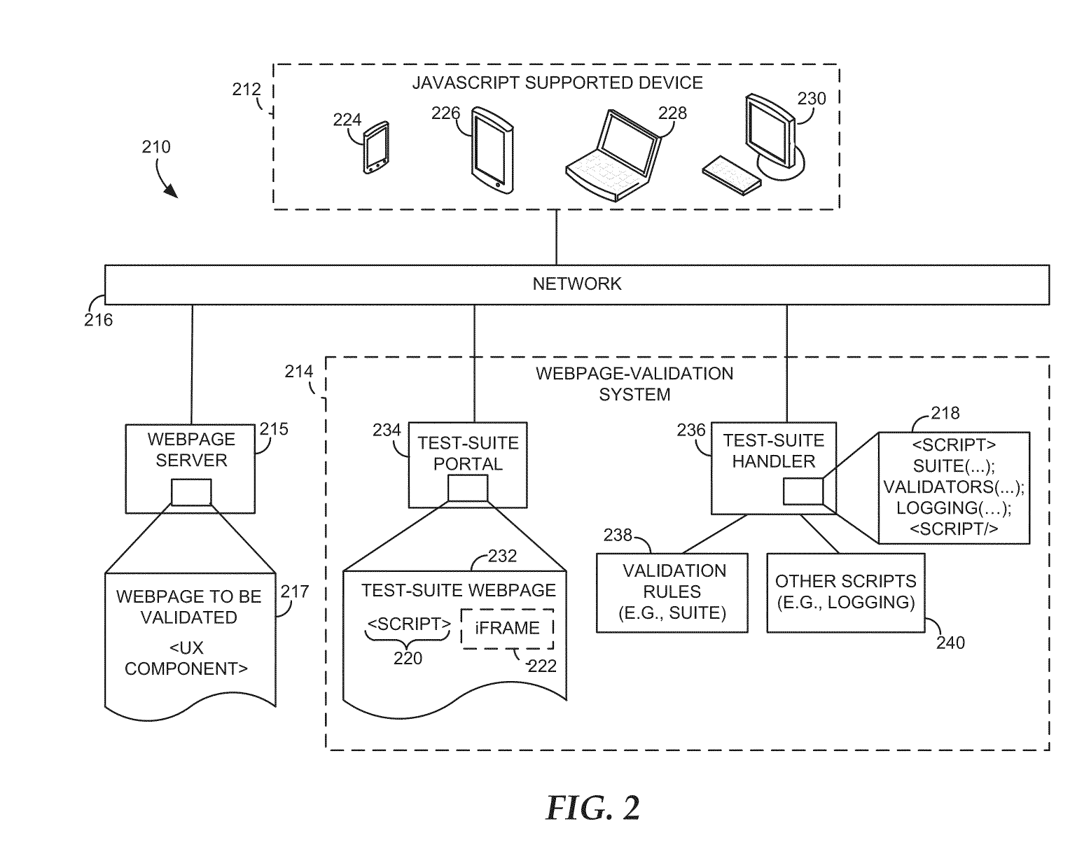

Referring now to FIG. 2, an exemplary environment 210 is illustrated in which embodiments of the present invention might be carried out. FIG. 2 includes a computing device 212 that is JavaScript enabled. The computing device 212 communicates with a webpage-validation system 214 and a webpage server 215 by way of a network 216, such as the Internet. In an embodiment of the invention, the device 212 is used to validate a webpage 217 by requesting a test script 218 provided by the webpage-validation system 214. The test script 218 is inserted into a tag 220, and the webpage 217 to be tested is launched in an iFrame 222. A handler is provided to every test case for logging and error detection.

The device 212 might include any device running a browser that supports JavaScript. As illustrated, the device 212 might include a smartphone 224, a laptop 226, a tablet 228, or a desktop 230; however, these are merely exemplary types of computing devices and the device 212 might include other types of devices (e.g., gaming console) as well. In accordance with an embodiment of the invention, the device 212 that supports JavaScript is used to validate the webpage 217. That is, the device 212 is used to determine whether the webpage 217 is rendered properly in a particular rendering context. “Rendering context” refers to hardware, software, or a combination thereof, that is used to read, present, and execute some or all of the components of a webpage. Examples of items that might define a rendering context include a particular device, a device type, device specs, an operating system, I/O components, a browser, or a combination thereof. In addition, examples of webpage components that are tested include user-interface components, such as a button, a link, a dropdown menu, and a textbox.

In an embodiment of the invention, the webpage 217 to be validated is registered with the webpage-validation system 214. When registering the webpage 217, the device 212 navigates to a test-suite webpage 232, which is provided by the webpage-validation system 214. That is, the device 212 leverages a browser running on the device 212 to request the test-suite webpage 232. Using the browser on the device 212, information is submitted to input portions of the test-suite webpage 232, thereby allowing information to be communicated to the webpage-validation system 214.

In an embodiment of the present invention, the test-suite webpage 232 is hosted by a server 234 that is included in the webpage-validation system 214 and that responds to a request from the device 212. The test-suite webpage 232 functions as a test-suite end point to collect information relevant for validating the webpage 217. That is, using the device 212, information is submitted to the webpage-validation system 214 by way of the test-suite webpage 232. Examples of information received by the webpage-validation system 214 includes an identifier (e.g., URL) of webpage 217, an identification of the rendering context, a specified use case of the webpage 217, and instructions for reporting results of the validation.

In an embodiment of the present invention, the information that is input to test-suite webpage 232 and that is received by the webpage-validation system 214 defines the rendering context(s). As such, the information might identify hardware, software, or a combination thereof to be used to render the webpage 217. Examples of rendering contexts include a device, a device type, device specs, a form factor, an operating system, I/O components, and a browser.

In addition, the information input to test-suite webpage 232 and received by the webpage-validation system 214 identifies the webpage 217. As such, the information might include a URL of the webpage 217. Although the webpage 217 is depicted to be stored remotely in environment 210, the webpage 217 might also be stored locally on the device 212.

In a further embodiment of the invention, the information input to test-suite webpage 232 and received by the webpage-validation system 214 identifies a specified use case of the webpage 217. For example, if the webpage 217 provides a service (e.g., search engine), a test input (e.g., test query) might be included in the information submitted to the webpage-validation system.

In other embodiments of the present invention, the information input to test-suite webpage 232 and received by the webpage-validation system 214 includes instructions for reporting results of the webpage validation. For example, the webpage-validation system 214 might receive instructions to email a validation report to a specified email address or to publish results at a particular URL.

In another embodiment of the invention, the information input to test-suite webpage 232 and received by the webpage-validation system 214 includes specific validation requests. For example, a specific validation request might request validation rules for certain components of the webpage 217. That is, a request might be received by the webpage-validation system 214 for rules to validate specified user-interface components of the webpage 217.

In a further embodiment of the present invention, one or more contexts are gathered from the client in an automated manner. Such automated collection of information might function in addition to, or as an alternative to, explicit input passed through test-suite webpage 232. Automated collection of contexts might be provided in various manners using JavaScript. For example, in one embodiment a User Agent string is read to gather various information embedded therein, such as information about the browser, platform, and the like.

The webpage-validation system 214 includes a test-suite handler 236, which receives the information input to test-suite webpage 232 and received by the webpage-validation system 214. The test-suite handler 236 processes the received information to generate the test script 218. As indicated in other parts of this description, the received information might include a webpage identifier, rendering context, logging/reporting instructions, specific use case(s), and the like.

As depicted in FIG. 2, the webpage-validation system stores validation rules 238. A validation rule is a set of JavaScript that is usable to run a test case of the webpage 217. The validation rules 238 are stored and maintained in an accessible data store. As such, the validation rules 238 are retrievable in response to a request for a test suite. In addition, the validation rules 238 are updatable to include additional validation rules when rendering contexts change (e.g., new devices with different form factors). In one embodiment, the validation rules 238 are organized based on rendering contexts. As such, a particular set of JavaScript can be referenced using the rendering context and is retrievable.

FIG. 2 also depicts that the webpage-validation system 214 includes other scripts 240 that are useful when executing a validation. For example, other scripts 240 include helper JavaScript files that provide logging, metrics, gathering, and other common user-interface validation helper methods. Similar to the validation rules 238, the other scripts 240 are searchable and retrievable by the test-suite handler 236 when the test script 218 is being generated. As such, using reporting instructions that are designated for validation of webpage 217 (e.g., during registration), appropriate helper scripts are selectable.

In an embodiment of the present invention, the test-suite handler 236 retrieves one or more rules from validation rules 236 based on the rendering context. For example, the test-suite handler 236 might retrieve a set of validation rules that apply to a specified device having a particular form factor. Using the retrieved validation rules, test-suite handler 236 builds the test suite and inserts required information, which was received from the device 212, into test cases. That is, validation rules retrieved from rules 238 are updated with any additional information submitted via test-suite webpage 232 to create an updated test suite. As such, test cases have the choice of using helper validation methods provided (e.g., link validation, button validation, textbox validation, dropdown validation, and the like) or using their own implementation for validating components. In a further embodiment, the test-suite handler 236 adds the appropriate logging and other common script handlers and files to the updated test suite to create the test script 218.

The webpage-validation system 214 provides the test script 218 to device 212. The test script 218 is created to be inserted into the tag 220 of the test-suite webpage 232. For example, the test script 218 might be inserted into the tag 220 of the test-suite webpage 232 rendered on the device 212.

In a further embodiment of the invention, the test-suite webpage (e.g., aspx page) launches an address (e.g., URL) of the webpage 217 to be tested in the iFrame 222. The test script 218 inserted into the tag 220 gets a handler to the page being rendered in the iFrame 222 and passes it to every test case. As indicated in other portions of the description, the test cases might use default or pre-determined helper validation methods (e.g., link validation, button validation, textbox validation, dropdown validation, etc.) or use a specified implementation for validating components.

In addition to validation errors, other types of errors might also be detected. For example, in an embodiment of the present invention, the framework is configured to look for all JavaScript errors being thrown by the webpage 217, in addition to validation errors described in other parts of this description. In this respect, the present invention enables JavaScript errors to be detected without requiring implementation by the webpage owner.

Using the logging scripts, logs generated by execution of the test scripts are reported (e.g., emailed or published to a URL), such that details describing a performance of the test cases are provided for user review. As such, errors that result from rendering components of the webpage 217 in the designated rendering context are identified and reported. Errors might be reported in various manners depending on the nature of the error. For example, validation errors might be reported in one section, whereas other types of errors might be reported in a different section. However, the present invention is configurable to report errors in a customized manner. Using this approach, components of the webpage 217 can be validated on a device that supports JavaScript without requiring the device to have appropriate drivers.

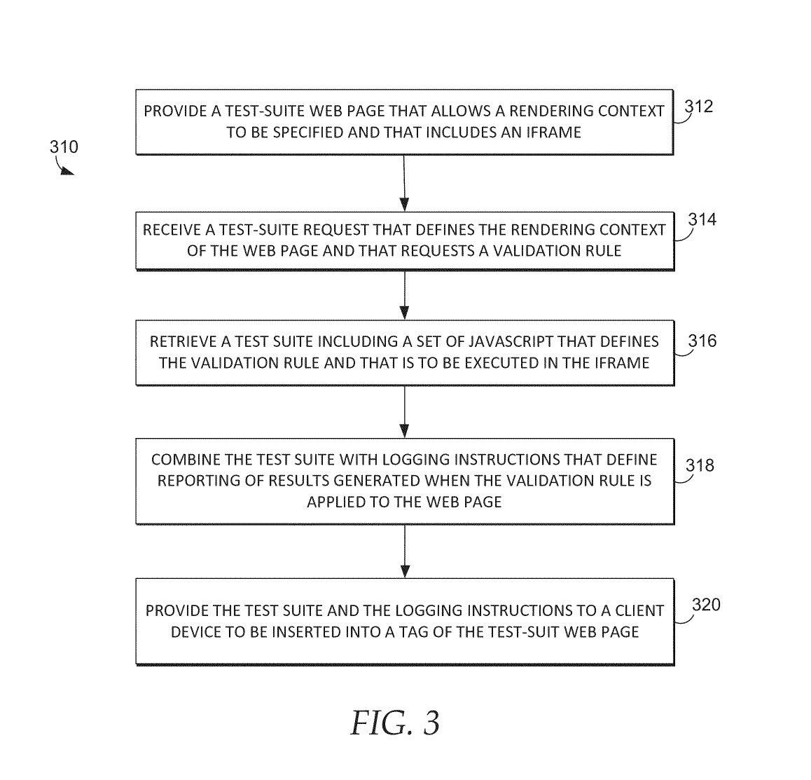

Referring now to FIG. 3, a flow diagram is depicted that illustrates a set of steps 310 for validating a webpage. The set of steps 310 might be performed as a method in accordance with an embodiment of the present invention. In addition, the set of steps 310 might be stored on computer-readable storage media as computer-executable instructions that, when executed by a computing device, provide a method of validating a webpage. When describing the set of steps 310 reference might also be made to FIG. 2.

In the set of steps 310, step 312 includes providing a test-suite web page that allows submission of rendering context (i.e., of the webpage to be validated) and that includes an iFrame. For example, in FIG. 2 the webpage-validation system 214 (or a server 234 that is part of the system) provides the test-suite webpage 232. As described in other portions of this description, the test-suite webpage 232 includes input portions that allow information (e.g., rendering contexts) to be submitted to the webpage-validation system 214. In addition, the test-suite webpage 232 includes an iFrame 222.

Step 314 includes receiving a test-suite request that defines the rendering context of the web page and that requests a validation rule. For example, the webpage-validation system 214 receives a test-suite request when information is submitted from the device 212 via the test-suite webpage 232 or is collected in an automated manner. The submission from the device 212 includes a request to receive the test script 218, which includes one or more validation rules. In addition, the request includes information that defines the rendering context (e.g., hardware and software to be used to render the webpage 217).

At step 316 a test suite is retrieved including a set of JavaScript that defines the validation rule and that is to be executed in the iFrame. The validation rule is executable to determine whether a component of the web page will be valid when the webpage is rendered in the rendering context. For example, in FIG. 2 the test-suite handler 236 retrieves a test suite from validation rules 238 that includes a set of JavaScript, which is to be executed using iFrame 222. The validation rule is executable in iFrame 222 to determine whether a component of the webpage 217, which is launched in iFrame 222, will be valid in a test case running the rendering context. Examples of components to be validated include UX components, web-page operations (e.g., search-result ranking), and the like.

Step 318 includes combining the test suite with logging instructions that define reporting of results generated when the validation rule is applied to the web page. For example, the test-suite handler 236 gathers and adds logging and other scripts 240, which provide instructions for reporting results of running a test case applying the validation rule.

In step 320 the test suite and the logging instructions are transmitted to a client device to be inserted into a tag of the test-suit web page. For example, the webpage-validation system 214 provides the test script 218 to the device 212 to be inserted into the tag 220.

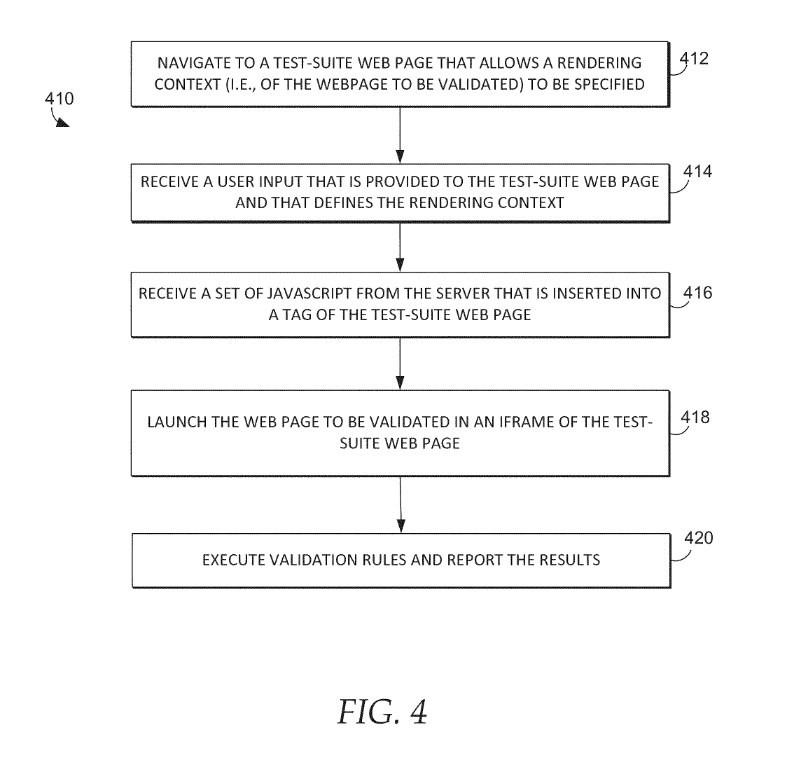

Referring now to FIG. 4, a flow diagram is depicted that illustrates a set of steps 410 for validating a webpage. The set of steps 410 might be performed as a method in accordance with an embodiment of the present invention. In addition, the set of steps 410 might be stored on computer-readable storage media as computer-executable instructions that, when executed by a computing device, provide a method of validating a webpage. When describing the set of steps 410 reference might also be made to FIG. 2.

Step 412 includes navigating to a test-suite web page that allows a rendering context (i.e., of the webpage to be validated) to be specified. For example, the device 212 might navigate to the test-suite webpage 232, which allows a rendering context of webpage 217 to be specified. At step 414 a user input is received that is provided to the test-suite web page and that defines the rendering context. Information describing the rendering context might be obtained in other manners, such as in an automated fashion described in other parts of this description. The user input is provided to a server. For example, the device 212 receives information that is input to the test-suite webpage 232 when the test-suite webpage is rendered thereon, and the device 212 provides the information to a server of the webpage-validation system 214.

In step 416 a set of JavaScript received from the server is inserted into a tag of the test-suite web page, wherein the set of JavaScript defines a validation rule. The validation rule determines whether a component of the web page will be valid when the web page is rendered in the rendering context. For example, the device 212 receives the test script 218 from a server of the webpage-validation system 214, wherein the test script defines a validation rule. As described in other parts of the description, the validation rule in the test script 218 determines whether a component of the web page 217 will be valid when the web page 217 is rendered in the rendering context (e.g., device with form factor).

At step 418 the web page to be validated is launched in an iFrame of the test-suite web page, which applies the validation rule defined by the set of JavaScript to the web page, to determine whether the component of the web page will render properly in the rendering context. For example, in FIG. 2 device 212 launches the webpage 217 in the iFrame 222 to apply the rendering-context validation rule defined in the test script 218. Further, step 420 includes executing the validation rules and reporting the results. For example, the validation rules included test script 218 are executed and results are reported according to the logging instructions.

Embodiments of the present invention are usable in various capacities to provide a server-hosted JavaScript solution for validating a webpage. Among other types of validation, rendering of UX components can be validated, as well as the operation of web-based services, such as search ranking. As such, a webpage might be validated using any device that supports JavaScript, and the device is not required to have a specific driver for the validation operations. Instead, a test script of collated JavaScript is provided to the client device, which launches the webpage to be tested in an iFrame

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

Claimed are:

1. A method of validating a web page comprising:
providing a test-suite web page that allows a rendering context of the web page to be specified and that includes an iFrame;
receiving a test-suite request that defines the rendering context of the web page and that requests a validation rule;
retrieving a test suite including a set of JavaScript that defines the validation rule and that is to be executed in the iFrame, wherein the validation rule determines whether a component of the web page will be valid when rendered in the rendering context;
combining the test suite with logging instructions that define reporting of results generated when the validation rule is applied to the web page; and
providing the test suite and the logging instructions to a client device to be inserted into a tag of the test-suit web page.

2. The method of claim 1, wherein the rendering context defined in the test-suite request includes a form factor of a computing device, and wherein application of the validation rule determines whether the component of the web page will be valid when the web page is rendered by the computing device having the form factor.

3. The method of claim 1, wherein the rendering context defined in the test-suite request includes a browser, and wherein application of the validation rule determines whether the component of the web page will be valid when the web page is rendered using the browser.

4. The method of claim 1, wherein the test suite includes a default validation rules and a specified-use validation rule.

5. The method of claim 4, wherein the specified-use validation rule tests a performance of the web page in the rendering context when the web page is used to execute a specified web-based function.

6. The method of claim 5, wherein the specified web-based function is a web search and wherein the specified-use validation rule is based on a test query received with the test-suite request.

7. The method of claim 1, wherein retrieving the test suite includes referencing a validation-rule datastore and looking up the test suite based on the rendering context defined in the test-suite request.

8. A system for validating a web page, the system including:
a computer-readable memory device that stores computer-executable instructions; and
a processor that is in communication with the computer-readable memory device and that executes the computer-executable instructions to:
provide a test-suite web page that allows a rendering context of the web page to be specified;
receive a test-suite request that defines the rendering context of the web page and that requests a validation rule;
retrieve a test suite from a JavaScript engine, wherein the test suite includes a set of JavaScript defining the validation rule, which determines whether a component of the web page will be valid when the web page is rendered in the rendering context;
transmit the test suite to a client device to be inserted into a tag of the test-suit web page.

9. The system of claim 8, wherein test-suite webpage includes an iFrame and wherein the test suite is to be executed in the iFrame.

10. The system of claim 8, wherein the validation rule is stored in association with the rendering context, and wherein retrieving the test suite includes looking up the validation rule based on the rendering context.

11. The system of claim 8, wherein the processor executes the computer-executable instructions to combine the test suite with logging instructions, which define reporting of results generated when the validation rule is applied to the web page.

12. The system of claim 8, wherein the rendering context includes a form factor of a computing device.

13. Computer-readable storage media storing computer executable instructions that, when executed by a computing device, perform a method of validating a web page, the method comprising:
navigating to a test-suite web page that allows a rendering context of the web page to be specified;
receiving a user input that is provided to the test-suite web page and that defines the rendering context, wherein the user input is provided to a server;
receiving from the server a set of JavaScript that is inserted into a tag of the test-suite web page and that defines a validation rule, which determines whether a component of the web page will be valid when the web page is rendered in the rendering context; and
launching the web page in an iFrame of the test-suite web page, which applies the validation rule defined by the set of JavaScript to the web page, to determine whether the component of the web page will render properly in the rendering context.

14. The media of claim 13, wherein the user input defines a form factor of a computing device that is usable to render the web page.

15. The media of claim 13, wherein the user input defines a browser that is usable to render the web page.

16. The media of claim 13, wherein the component of the web page that is validated includes a user-interface component.

17. The media of claim 13, wherein the set of JavaScript includes default validation rules, web-page-specific validation rules, and logging instructions, which define reporting of results generated from application of the validation rule in the iFrame.

18. The media of claim 13, wherein the method further comprises transmitting results of the application of the validation rule to a recipient specified in the set of JavaScript.

19. The media of claim 13, wherein the computer-executable instructions are executed by a first computing device and wherein the validation rule determines whether the component of the web page will render properly by a second computing device, which includes a form factor that is different than the first computing device.

20. The media of claim 13, wherein receiving the user input includes receiving a specified use case that is input to the test-suite web page, and wherein the specified use case is submitted to the server.
